(19) United States
(12) Patent Application Publication
(10) Pub. No.: US 2006/0027645 A1
(43) Pub. Date: Feb. 9, 2006

(54) Identification tag with item holding feature

(76) Inventor: Daniel H. Granick, Buffalo Grove, IL (US)

Correspondence Address: GREENBERG TRAURIG, LLP, 77 WEST WACKER DRIVE, SUITE 2500, CHICAGO, IL, 60601-1732, US

(21) Appl. No.: 11/057,490

(22) Filed: Feb. 14, 2005

Related U.S. Application Data
(60) Provisional application No. 60/544,084, filed on Feb. 12, 2004.

(51) Int. Cl. G06K 5/00; G06K 7/00

(52) U.S. Cl. 235/380; 235/486

(57) ABSTRACT

An identification tag with an item-holding feature comprises a tag body, a compartment adjacent the tag body for securely holding at least one personal item therein, and means for securing the at least one personal item within the compartment. The personal item may comprise a pocket knife, a key, or other desired item.

This application claims the benefit of U.S. Provisional Application No. 60/544,084, filed Feb. 12, 2004, the complete disclosure of which is hereby specifically incorporated by reference.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE DISCLOSURE

1. Field of the Invention

The present invention is directed to an identification tag including an item holding feature for use on personal articles, such as pieces of luggage, and, more specifically, to a luggage tag having an integral compartment for holding small items detected by airline security machines, such as metal detectors, carried onto aircrafts by airline passengers.

2. Background Art

Recent concerns relating to airline security have resulted in stricter regulations relating to items which may or may not be carried onto aircraft by airline passengers. As a result, many airline passengers have been forced to surrender various personal items no longer permitted to be brought onto aircraft, such as pocket knives, nail files, scissors and the like, prior to passing through airport security. Airline passengers desiring to transport such items must now place them into checked baggage prior to boarding a flight. This has proved to be inconvenient for travelers who regularly carry small personal items, such as pocket knives, which cannot be carried onto an aircraft, as such individuals must store these items in their checked baggage prior to check-in at the airport. Furthermore, upon arrival, the traveler must then open their luggage in order to retrieve such items, resulting in a further inconvenience.

It would therefore be desirable to provide an identification tag having an item holding feature which is suitable for use as a luggage tag. It would further be desirable to provide such an identification tag capable of holding personal items which may not be permitted to be carried onto aircraft, and to enable individuals traveling with such items to easily store them prior to boarding a flight and to retrieve them thereafter without having to open the individual's luggage.

### SUMMARY OF THE INVENTION

An identification tag with item holding feature according to the present invention comprises a tag body; a compartment for securely holding a personal item therein, the compartment being located adjacent to the tag body; and means for securing the personal item within the compartment. The identification tag preferably includes a strap for attachment to an article of luggage.

The tag body further comprises a top side and a bottom side, and includes a display opening for inserting an identification-bearing element, such as a business card, between the top side and the bottom side. The top side preferably includes a transparent display window through which the identification-bearing element is visible.

The identification tag further comprises a closure flap. The securing means may comprise a snap fastener or a hook-and-loop fastener associated with the item holder and the closure flap. Alternatively, the securing means may comprise a biasing means exerting a force on the closure flap.

The personal item may comprise a pocket knife, a key, or any other item which causes difficulty in passing through metal detectors and the like in security environments.

### BRIEF DESCRIPTION OF THE DRAWINGS

FIG. 1 is a top plan view of a preferred embodiment of an identification tag according to the present invention.

FIG. 2 is a bottom plan view of the identification tag of FIG. 1.

FIG. 3 is a bottom plan view of the identification tag of FIG. 1, in which the item has been removed from the item holder.

FIG. 4 is a side view of the identification tag of FIG. 1.

### DETAILED DESCRIPTION OF THE DRAWINGS

While this invention is susceptible of embodiment in many different forms, there is shown in the drawings, and will be described in detail herein, one specific embodiment, with the understanding that the present embodiment is to be considered as an exemplification of the principles of the invention and is not intended to limit the invention to the embodiments illustrated.

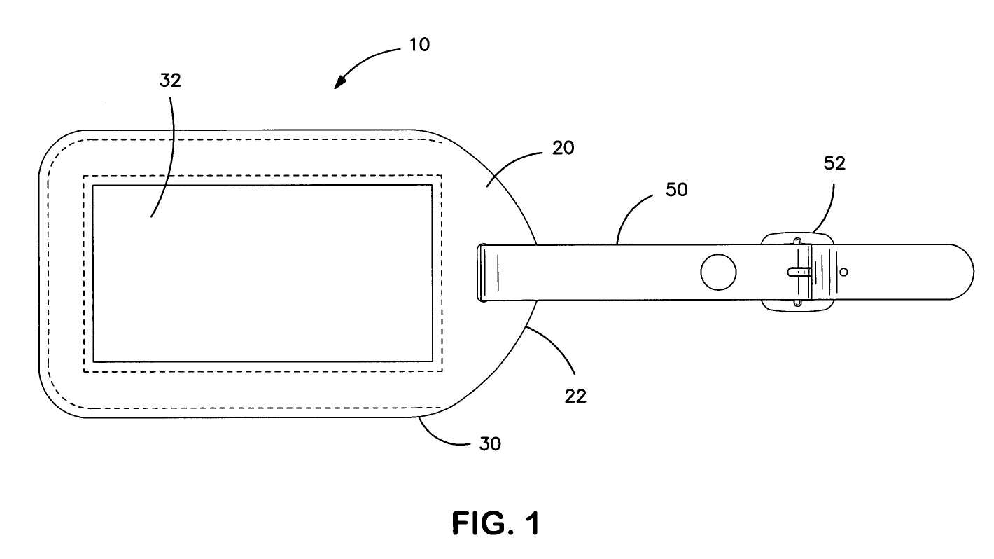

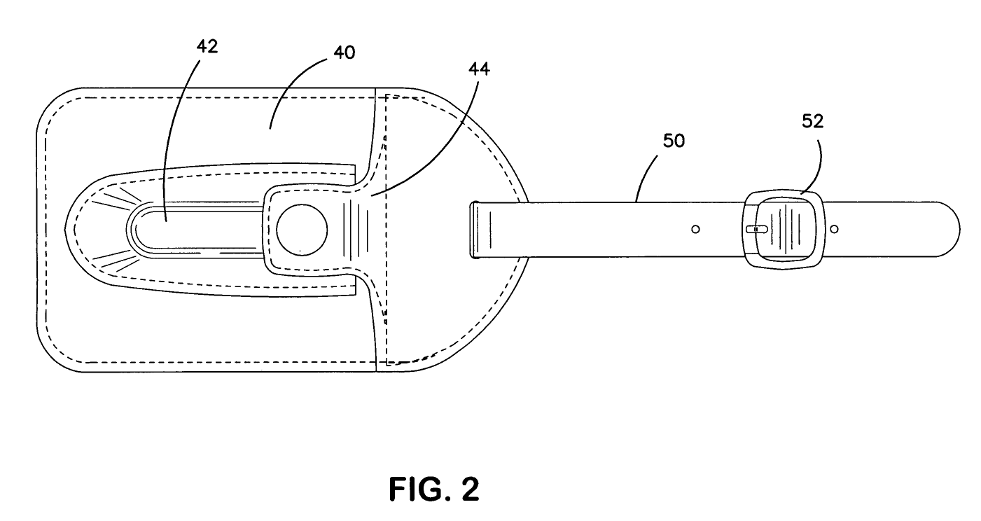

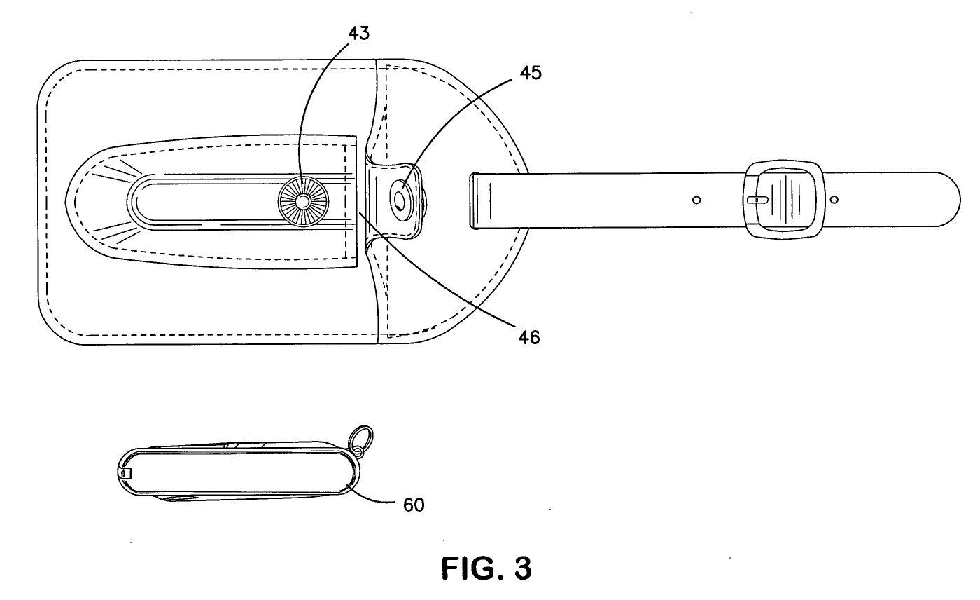

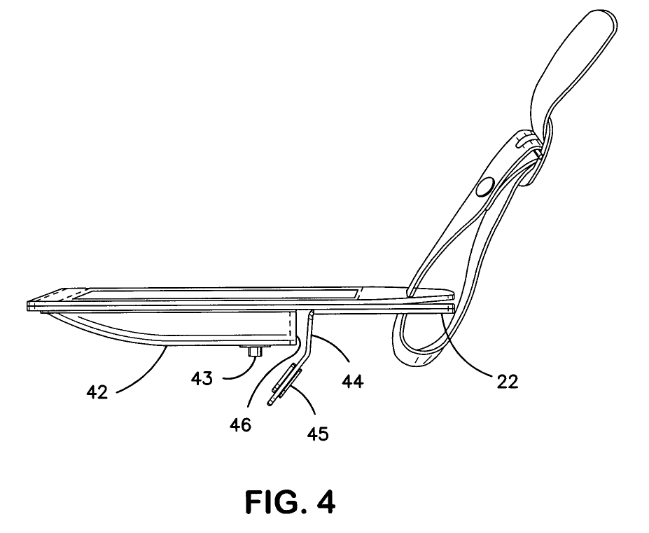

Identification tag 10 is shown in FIGS. 1-4 as comprising tag body 20 and attachment strap 50. Tag body 20 further comprises opening 22, top side 30, bottom side 40 and item holder 42. Strap 50 further comprises buckle 52, to enable releasable attachment of identification tag 10 to a piece of luggage or other desired article (not shown) by conventional means.

Identification tag 10 may be constructed of any preferred material commonly used for such tags, typically leather or plastic. While identification tag 10 is shown in the preferred embodiment as comprising a rectangular-shaped tag of a size typically used as an identification tag for luggage, it may comprise any desired size or shape, and is not limited to use solely in a luggage environment. Identification tag 10 may likewise be either flexible or rigid, as desired.

Top side 30 further includes display window 32, preferably comprising a transparent plastic member adapted to cover a business card or other identification-bearing element placed therewithin. Such identification-bearing element may be inserted within tag body 20 by means of opening 22, as is known in the art. Bottom side 40 further comprises closure flap 44.

Item holder 42 is positioned adjacent bottom side 40, and is shaped so as to receive a desired item 60 therein which, in the case of the illustrated preferred embodiment, comprises a small pocket knife. However, item holder 42 may take various other shapes and sizes as desired, depending on the nature of the item of interest—for example, nail files, scissors, or any other desired item. Item holder 42 may also be positioned elsewhere, such as the top side, on tag 10 as operation would allow. Moreover, item 60 may comprise a key for use with a lock used to secure the piece of luggage, so as to permit airport security officials to open the piece of luggage if necessary, without having to destroy the lock thereon. Additionally, item holder 42 may be divided into multiple compartments for holding multiple items, if desired.

Item holder 42 further includes fastener base 43 and item holder opening 46. Closure flap 44 further includes fastener top 45. Fastener base 43 and fastener top 45 preferably comprise complementary sections of a conventional snap fastener, as is known in the art, to enable the securing of closure flap 44 to item holder 42 in a conventional manner. Other conventional means of fastening closure flap 44 to item holder 42, such as hook-and-loop fasteners, buckles, or buttons, may be used in place of a snap fastener as desired. Alternatively, closure flap 44 may comprise a hinged flap which is biased against item holder 42, such as by a spring, so as to cause closure flap 44 to remain in a position closing item holder opening 46 until a force is applied in an opposite direction, thereby obviating the need for a separate fastener element.

In order to utilize tag 10, the user first attaches tag 10 to a desired piece of luggage or other article by means of strap 50. Upon arrival at the airport check-in counter, or other security check points, the user inserts item 60 into item holder 42 by way of item holder opening 46. Item 60 can then be secured within item holder 42 by positioning closure flap 44 over item holder opening 46, and then joining fastener base 43 and fastener top 45. The user then checks the piece of luggage through to his destination, during which item 60 remains secured within item holder 42. Upon retrieval of the luggage at the destination, item 60 may be easily and conveniently removed from item holder 42, without the need to open the piece of luggage and search through the inside thereof.

The foregoing description and drawings merely explain and illustrate the invention, and the invention is not limited thereto except insofar as the pending claims are so limited, as those skilled in the art and having the present disclosure before them will be able to make modifications and variations therein without departing from the scope of the invention.

What is claimed is:

1. An identification tag with an item holding feature, the identification tag comprising:
a tag body;
a compartment for securely holding at least one personal item therein, the compartment being operably positioned adjacent the tag body; and
means for securing the at least one personal item within the compartment.

2. The identification tag of claim 1, further comprising a strap for attaching the identification tag to an article of luggage.

3. The identification tag of claim 1, wherein the tag body further comprises a top side and a bottom side.

4. The identification tag of claim 3, wherein the tag body further comprises a display opening for inserting an identification-bearing element for receipt between the top side and the bottom side.

5. The identification tag of claim 4, wherein the top side further comprises a transparent display window through which the identification-bearing element is visible.

6. The identification tag of claim 1, further comprising a closure flap.

7. The identification tag of claim 6, wherein the securing means comprises a snap fastener associated with the item holder and the closure flap.

8. The identification tag of claim 6, wherein the securing means comprises a hook-and-loop fastener associated with the item holder and the closure flap.

9. The identification tag of claim 6, wherein the securing means comprises a biasing means exerting a force on the closure flap.

10. The identification tag of claim 1, wherein the at least one personal item comprises a pocket knife.

11. The identification tag of claim 1, wherein the at least one personal item comprises a key.
